(19) United States
(12) Patent Application Publication
(10) Pub. No.: US 2003/0075382 A1
(43) Pub. Date: Apr. 24, 2003

(54) Method for making a surface mechanical wave absorbing material and resulting electro-acoustic transducer

(76) Inventor: Pierre Fontaine, Herblay (FR)

Correspondence Address: MARSHALL, GERSTEIN & BORUN, 6300 SEARS TOWER, 233 SOUTH WACKER, CHICAGO, IL, 60606-6357, US

(21) Appl. No.: 10/148,754

(22) PCT Filed: Dec. 18, 2000
(86) PCT No.: PCT/FR00/03578

(30) Foreign Application Priority Data
Dec. 16, 1999 (FR) 9915877

(51) Int. Cl. B05D 3/02; G10K 13/00

(52) U.S. Cl. 181/173; 427/385.5; 264/45.4; 264/255

(57) ABSTRACT

The invention concerns a method for making a material absorbing surface mechanical wave generated by local waves capable of producing interference phenomena relative to the pressure wave with propagation direction orthogonal to said surface. The method consists in forming a support (S) delimiting the surface from a continuous structure, said support having a specific rigidity in a direction substantially orthogonal to said support (S). An sound-absorbing coat (R) is then formed on at least one surface of the support (S), said coat comprising a plurality of obstacles to the propagation of the surface mechanical wave and the local waves, which are thus absorbed. The invention is useful for making diaphragms for electro-acoustic transducers and high quality electro-acoustic transducers.

The invention relates to a method of making a material absorbing surface mechanical waves, a material absorbing surface mechanical waves obtained by the implementation of this method, and the electroacoustic transducers thus obtained and used in sound reproduction.

With the advent of multimedia information exchanges, and on account in particular of the very considerable work carried out in the area of the digital processing of video and/or audio signals so as to ensure the compression of these signals, their transformation under satisfactory conditions, their storage and their restitution under optimal conditions, in particular as regards the physiological quality of musical sounds, tools for sound reproduction, that is to say essentially electromechanical or electroacoustic transducers allowing the transmission of these digital and/or analog signals as acoustic pressure waves have remained the poor relations of these developments.

Currently, it is common to have to devote a considerable budget to the purchase of acoustic cabinets furnished with conventional electromagnetic transducers, such as tweeters and low-frequency loudspeakers, for a quality/price ratio which often proves to be rather disappointing.

The disappointment, sometimes masked by the belief that one has acquired the most modern technologies currently on offer, is caused essentially by the ever imperfect reproduction of sounds, such as the aforesaid musical sounds, on account of the ever present coloration of the sounds reproduced, owing to the nature of the materials used for fabricating these electromechanical transducers.

Thus, it is fairly usual to have to choose the brand of materials and sound reproduction apparatus as a function of the type of sounds to be reproduced, and, within the brand chosen, to favor the adoption of a fairly specific model, as a function of the latter's sound rendition. It is recalled in fact that the phenomenon of the coloration of reproduced musical or vocal sounds is due essentially to the introduction, into the reproduced acoustic pressure wave, of frequency components related directly to the nature of the constituent material of the vibrating part of the electromechanical transducer used.

The object of the present invention is to eliminate or substantially reduce the drawbacks of the electromechanical or electroacoustic transducers of the prior art by eliminating or at least significantly attenuating the aforesaid phenomenon of coloration.

In particular, the object of the present invention is the implementation of a method of making a material which absorbs surface mechanical waves generated locally on the surface of this material, when the latter is subjected to a mechanical excitation aimed at creating a pressure wave reproducing an acoustic wave.

Furthermore, the object of the present invention is to provide a material which absorbs surface mechanical waves generated locally on the surface of this material, when the latter is subjected to a mechanical excitation aimed at creating a pressure wave for reproducing an acoustic wave.

Finally, the object of the present invention is to provide electromechanical or electroacoustic transducers comprising an electromagnetic motor and a diaphragm furnished with an excitation coil, this diaphragm linked by a suspension being constructed from a material in accordance with the subject of the invention.

More specifically, the method of making a material absorbing a surface mechanical wave generated by local waves which are capable of generating interference phenomena in relation to a pressure wave whose direction of propagation is substantially orthogonal to this surface, is noteworthy in that it consists in forming a support delimiting this surface on the basis of a continuous structure, this support exhibiting a specified rigidity in a direction substantially orthogonal to the surface of this support, and in forming on at least one of the faces of this support an absorbent coating which absorbs this surface mechanical wave and the local waves, this absorbent coating exhibiting a plurality of obstacles to the propagation of this surface mechanical wave and of the local waves.

The absorbent material absorbing a surface mechanical wave generated by local waves which are capable of generating interference phenomena in relation to a pressure wave whose direction of propagation is substantially orthogonal to this surface, when this material is subjected to a mechanical action aimed at creating a pressure wave for reproducing an acoustic wave, is noteworthy in that it comprises a base consisting of a support delimiting this surface, which support is formed on the basis of a continuous structure, said support exhibiting a specified rigidity in a direction substantially orthogonal to this support and an absorbent coating which exhibits a plurality of obstacles to the propagation of this surface mechanical wave and of the local waves.

The electroacoustic transducer which is the subject of the invention comprises an electromagnetic motor and a diaphragm furnished with an excitation coil, this diaphragm possibly being linked by a suspension to a rigid frame. It is noteworthy in that the diaphragm is constructed from a material in accordance with the subject of the invention.

The material absorbing surface mechanical waves and local waves, the method of making this material and the electroacoustic transducers implemented in accordance with the object of the present invention find application in the manufacture of high-fidelity video and/or audio frequency kit and equipment of very high quality.

They will be better understood on reading the description below and on looking at the drawings in which, apart from

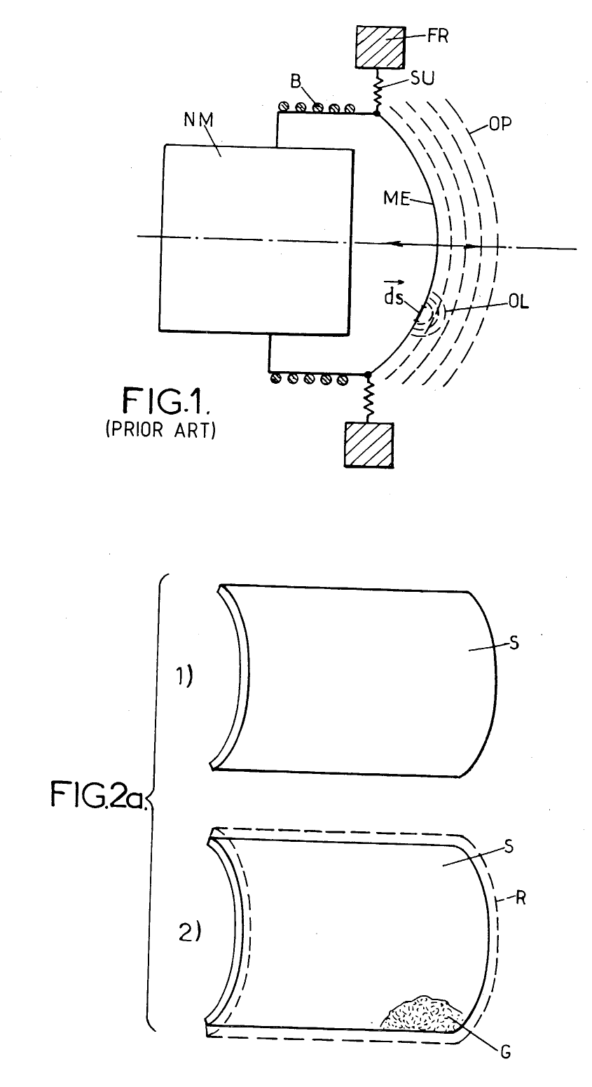

FIG. 1 relating to the prior art:

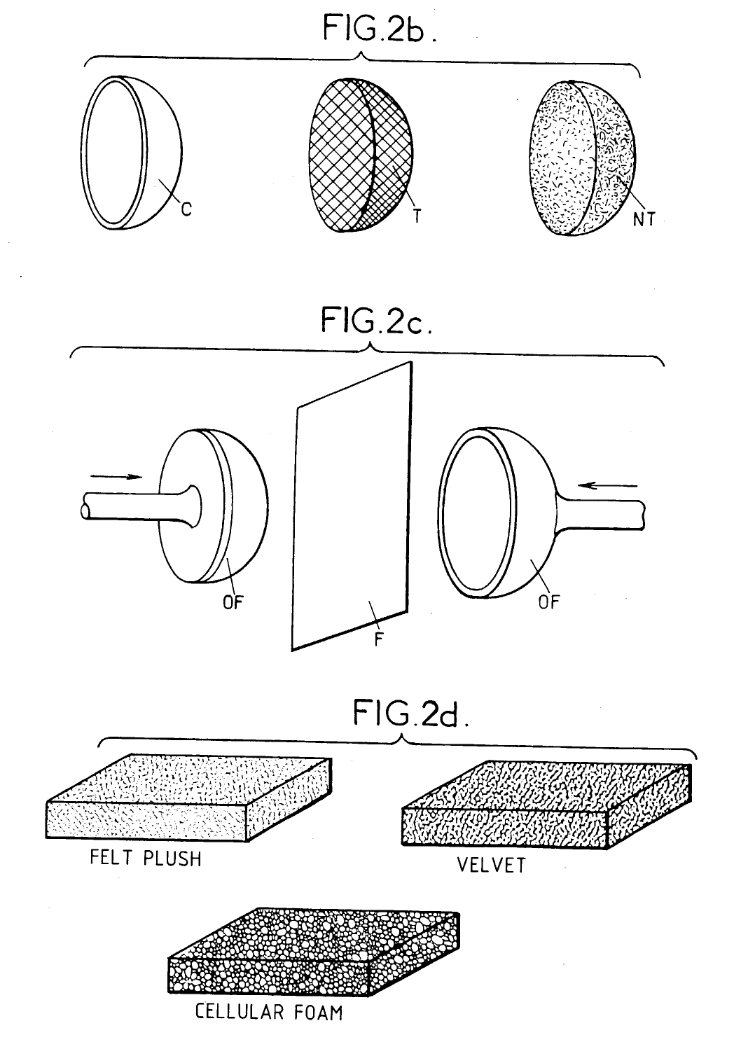

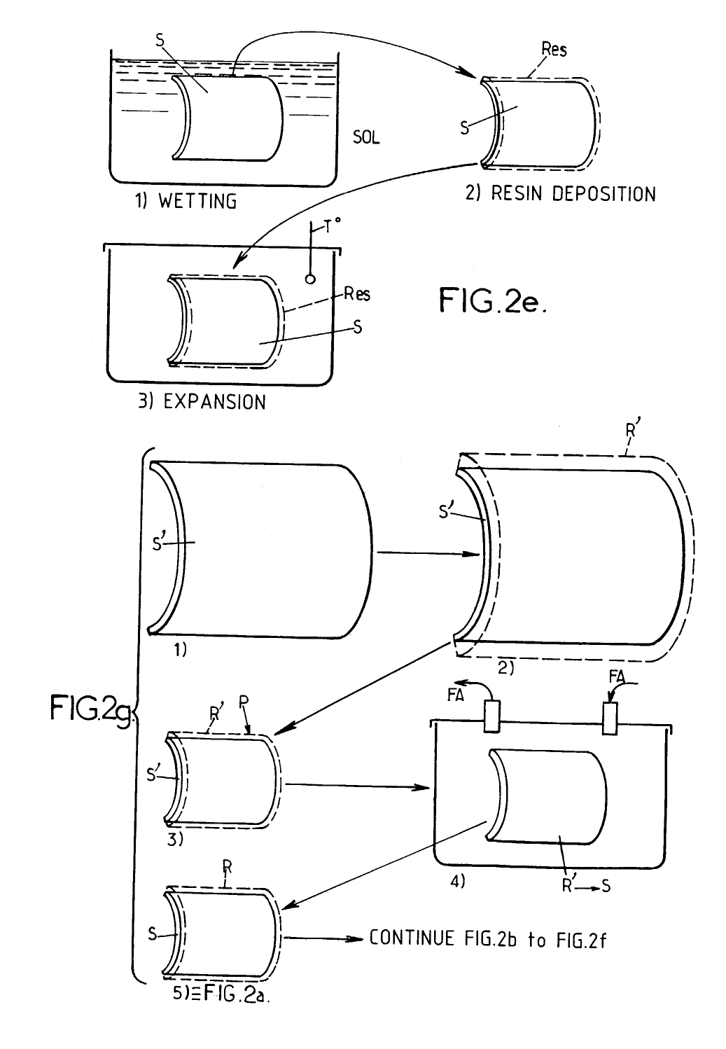

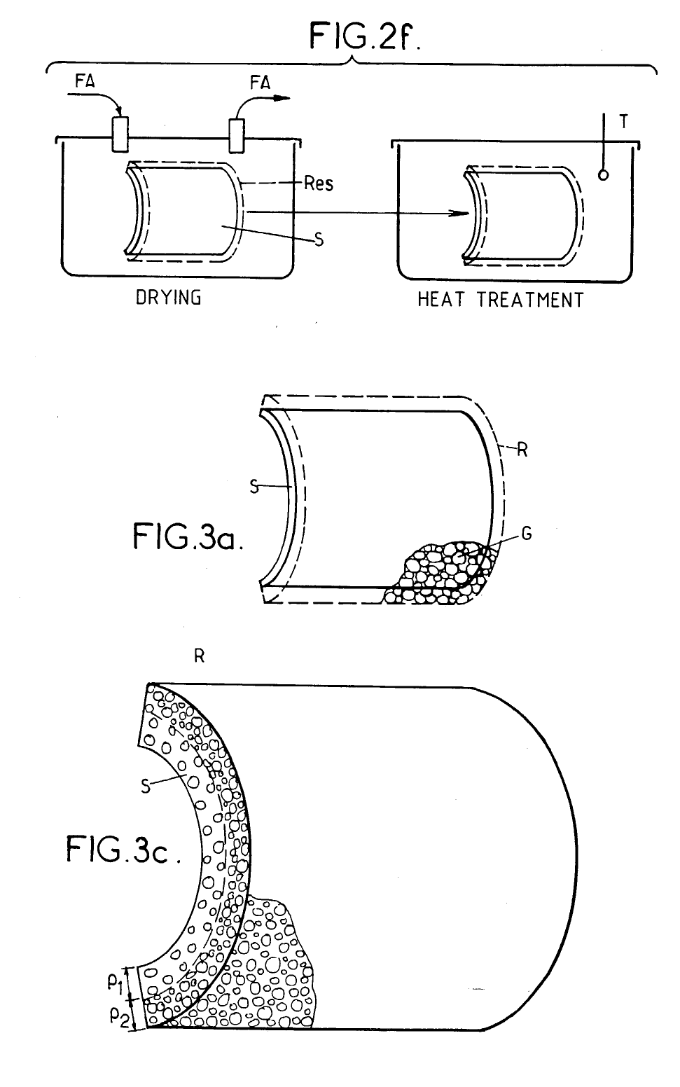

FIG. 2a represents, by way of illustration, the essential steps for implementing the method of making a material absorbing surface mechanical waves and local waves which is the subject of the invention;

FIGS. 2b, 2c, 2d represent various details of the implementation of the method illustrated in FIG. 2a;

FIGS. 2e, 2f and 2g represent, in a nonlimiting manner, a specific mode of implementation of the method which is the subject of the present invention;

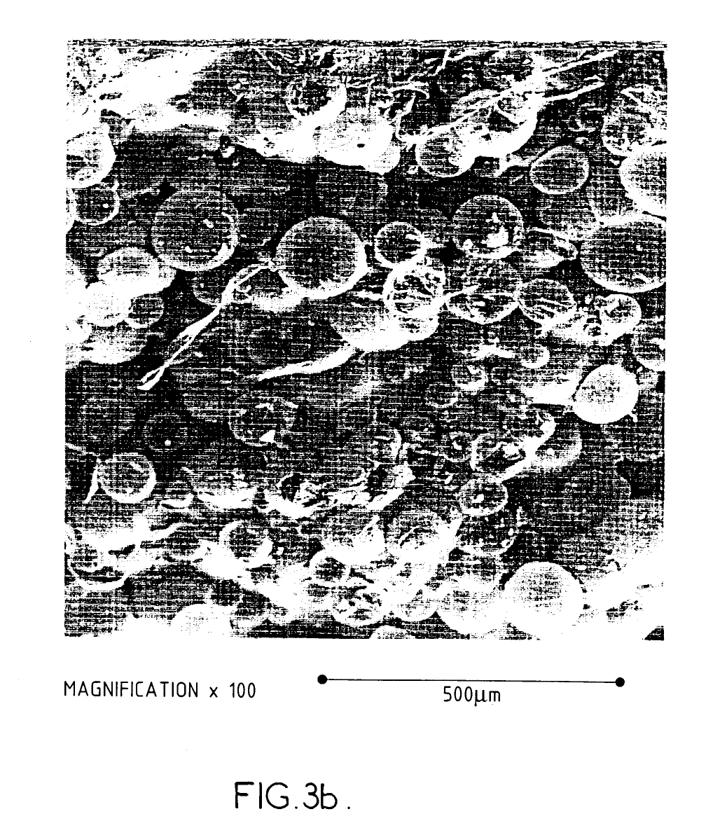

FIGS. 3a, 3b and 3c represent various aspects of the material absorbing a surface mechanical wave generated by local waves which are capable of generating interference phenomena in relation to a pressure wave whose direction of propagation is substantially orthogonal to this surface, in accordance with the subject of the invention;

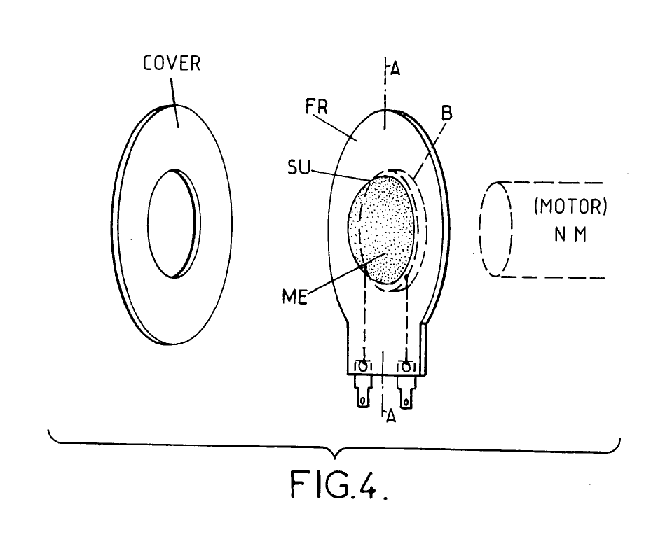

FIG. 4 represents, in a nonlimiting manner, an electroacoustic transducer in accordance with the subject of the present invention;

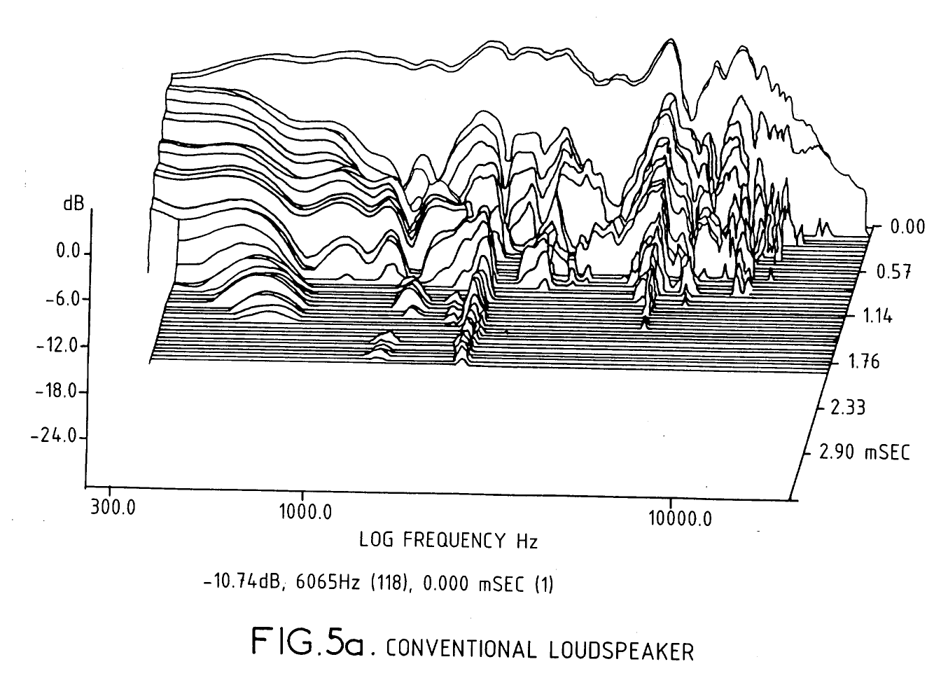

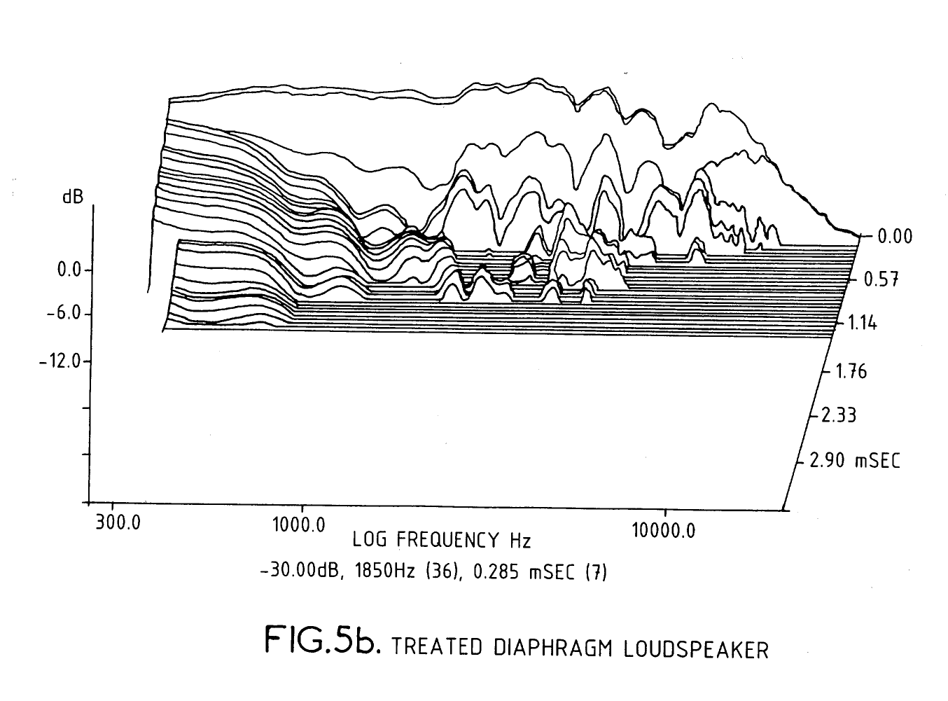

FIGS. 5a and 5b represent a time, frequency, sound signal amplitude chart for a loudspeaker of conventional type and a loudspeaker of similar type respectively, in which the conventional diaphragm has been replaced by a diaphragm obtained in accordance with the subject of the invention;

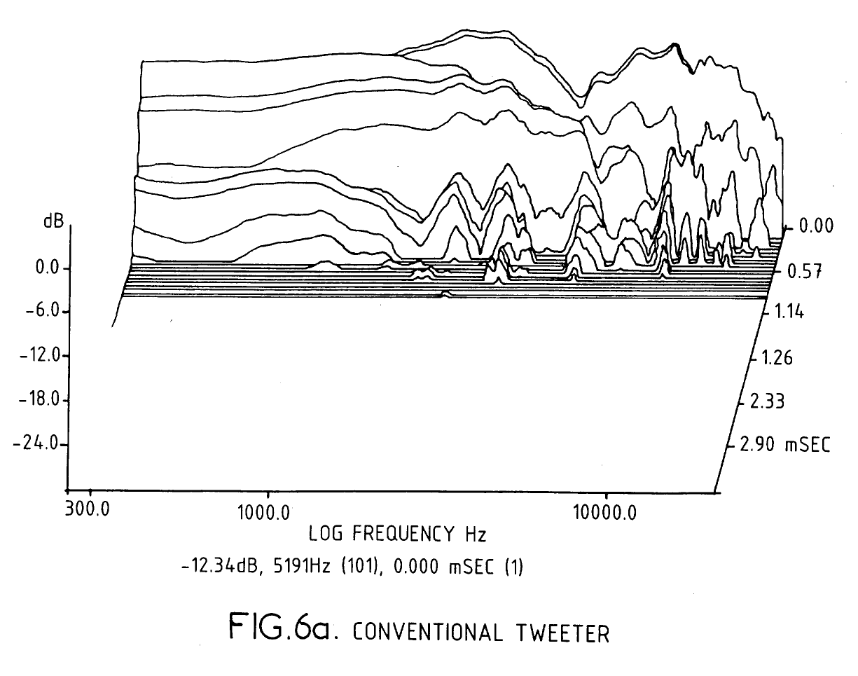

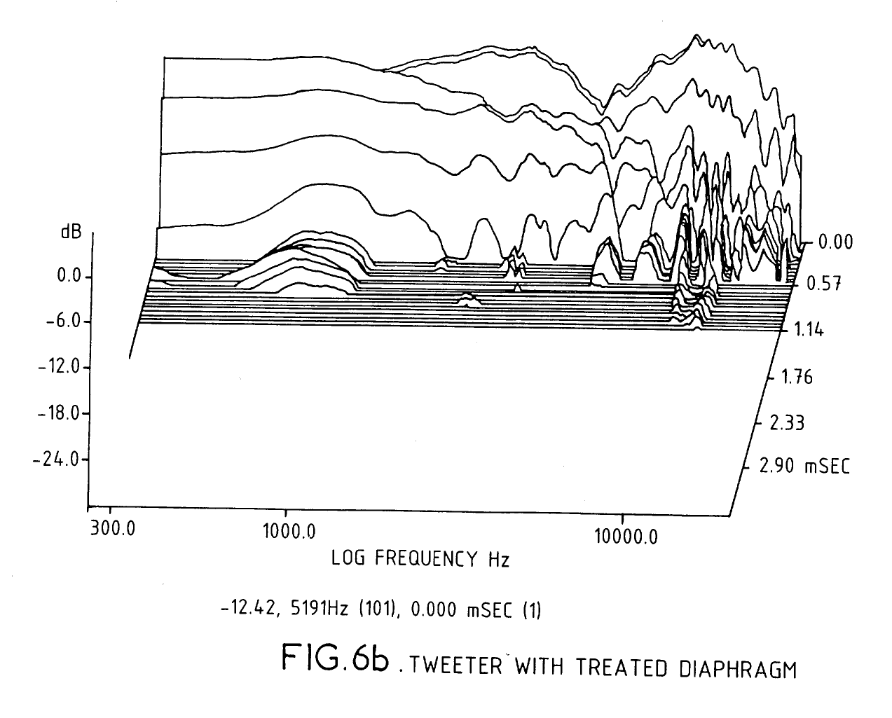

FIGS. 6a and 6b represent a time, frequency, sound signal amplitude chart for a tweeter of conventional type and a tweeter of similar type respectively, in which the conventional diaphragm has been replaced by a diaphragm obtained in accordance with the subject of the invention.

Prior to the description of the method of making a material absorbing surface mechanical waves, of the material absorbing surface mechanical waves and of electroacoustic transducers obtained in accordance with the subject of the present invention, various reminders relating to the phenomena involved during the reproduction of an acoustic wave by an electroacoustic transducer of conventional type will now be given in conjunction with FIG. 1.

In FIG. 1, and within the framework of the restitution of an acoustic wave, pressure wave EP, by an electroacoustic transducer such as a tweeter for example, comprising a dome-shaped diaphragm ME linked by an elastic suspension SU to a rigid frame FR, the diaphragm being moreover furnished with an excitation coil B which is excited by the audio analog signal representative of the sound signal, the excitation of the coil B by the aforesaid audio signal has the effect of causing the displacement of the diaphragm ME by way of the electromagnetic motor consisting of the magnetic core NM and of the aforesaid coil B subjected to the excitation. Under these conditions, the displacement of the diaphragm ME causes an acoustic wave of the plane wave or substantially plane wave type OP reproducing the aforesaid sound signal.

However, the diaphragm ME is subjected locally, at the level of surface elements d\vec{S} to microdeformations which are due to local imperfections of the aforesaid diaphragm as well as to the structure of this diaphragm when this diaphragm consists of a woven element for example in which the woven structure exhibits periodic or nonperiodic zones of weakening.

Under these conditions, it is indicated that each elementary surface zone d\vec{S} may be the seat of microdeformations which generate local waves OL such as represented in FIG. 1, these local waves exhibiting the particular feature of constituting waves which are substantially spherical in relation to the radius of curvature of the pressure wave OP but of much smaller pressure amplitude. Under these conditions, although the pressure wave OP exhibits a direction of propagation substantially orthogonal to the surface of the diaphragm OE, the local waves OL, although of much smaller amplitude than the pressure wave OP, are capable of generating phenomena modifying the overall phase of the carrier wave OP, these local waves OL in fact having a propensity to propagate in the neighborhood of the surface of the diaphragm ME and thus to constitute an interference surface wave capable of disturbing the conditions of propagation of the aforesaid pressure wave OP. It is understood in particular that although the contribution of each local wave OL in the direction orthogonal to the surface of the diaphragm ME may appear negligible, this contribution, along the surface of the diaphragm ME and of any equipressure plane in the neighborhood thereof is then no longer negligible, this giving rise to the creation of an equivalent surface wave.

The object of the present invention is to remedy the propagation of this surface mechanical wave and, in particular, of the local waves mentioned previously in conjunction with FIG. 1.

In general, the object of the invention is to provide a material furnished with a coating making it possible to absorb, or at the very least to significantly attenuate, the propagation of the surface mechanical wave and of the local waves mentioned previously.

A more detailed description of a method of making a material absorbing a surface mechanical wave capable of generating interference phenomena in relation to a pressure wave whose direction of propagation is substantially orthogonal to this surface, will now be given in conjunction with FIG. 2a.

With reference to the aforesaid figure, it is indicated that the method which is the subject of the present invention consists in forming a support S delimiting the aforesaid surface from a continuous structure. The expression continuous structure is understood to mean either a solid structure in the form of a sheet or thin layer, or else a periodic structure which may exhibit hollows, the maximum dimension of the hollows being much less than the wavelength of the pressure wave OP and of the acoustic wave to be reproduced.

The aforesaid step is then followed by a step consisting in forming on at least one of the faces of the support S a coating which absorbs the surface mechanical wave and the local waves mentioned previously. In FIG. 2a, the coating is denoted R and is represented dashed on account of its structure which will be described subsequently in the description.

The absorbent coating R exhibits a plurality of obstacles to the propagation of the surface mechanical wave and of the aforesaid local waves.

Generally, it is indicated that the support S may advantageously be formed by a continuous structure, a composite structure, a woven or unwoven structure of fibers chosen from the group of inorganic or synthetic fibers such as nylon or other fibers.

Under these conditions, as represented in FIG. 2b, the support S can be shaped by forming, thermoforming, molding or stamping, blanking or trimming from a plate according to a predetermined forming profile. Represented in FIG. 2b is the support S consisting of a continuous cap C made of metal, such as aluminum for example, and formed by stamping, a cap formed by a weave of nylon fibers for example, shaped by thermoforming, and a support made of an unwoven material NT, formed for example of inorganic fibers or the like. The shaping by stamping of a sheet F is represented in FIG. 2c, on the basis of tools OF.

As far as the implementation of the absorbent coating R is concerned, it is indicated that the latter, in order to ensure the existence of a plurality of obstacles which are effective against the propagation of the surface mechanical wave and of the local waves, may advantageously exhibit a granular, fibrous or similar structure.

Under these conditions, as represented in FIG. 2d, and in accordance with a particularly advantageous aspect of implementation of the method which is the subject of the invention, the step consisting in forming an absorbent coating consists in adding a structure chosen from the group of plushes, velvets, cellular foams to at least one of the faces of the support, under the conditions which will be set forth hereinbelow.

A particularly advantageous specific mode of operation for producing the coating R, absorbent coating, will now be described in conjunction with FIG. 2e.

With reference to the aforesaid figure, it is indicated that the step consisting in forming the absorbent coating can, by way of nonlimiting example, consist in subjecting the support S to a surfactant accompanied by a wetting agent, the support S being for example dipped into a solution Sol consisting of the surfactant and the aforesaid wetting agent. The so-called wetting operation is carried out for a few minutes.

Following the aforesaid operation, the support S, after wetting, can be subjected to a step consisting in depositing at least one layer of resin, Res, comprising an acrylic layer on at least one of the faces of the support S. It is understood in particular that the depositing of the layer of resin can be performed by spreading over the face of the relevant support S.

Finally, the step of depositing resin is itself followed by a so-called expansion step, consisting in subjecting the assembly constituted by the support furnished with the layer of resin Res, this being done so as to make it possible to generate on the surface of the aforesaid layer of resin and of the support a surface structure of the plush, velvet or cellular foam type mentioned previously.

Generally, it is indicated that the expansion step can consist in a step of heating the assembly consisting of the support S and the resin Res, this assembly being subjected to a heat treatment at a temperature of between 120° and 250° as a function of the nature of the support S and of the aforesaid resin Res.

Various trials have been carried out so as to determine the best mode of operation for carrying out the expansion step mentioned previously and described in conjunction with FIG. 2e.

With reference to FIG. 2f it is indicated that the expansion step mentioned previously can consist firstly in subjecting the assembly consisting of the support S and the resin Res to a drying step, the aforesaid assembly being subjected to a current of ventilating air FA in a closed cabinet for, for example, an appropriate duration of a few minutes.

The aforesaid drying step can then be followed by a step of heat treatment proper, the assembly consisting of the support S and the resin Res being placed in an oven at a temperature of between 120° and 250° for example.

The carrying out of the expansion step in two substeps comprising a first drying step followed by a second heat treatment step as represented in FIG. 2f, when the drying step is carried out by a current of ventilating air FA, has the advantage of discharging the subproducts of drying and of thus subjecting the assembly consisting of the support S and the resin Res to the process of heat treatment in a substantially neutral atmosphere, that is to say in the absence of drying products, which have been discharged previously. This mode of operation thus makes it possible to ensure a process of expansion proper in the course of the heat treatment so as to ensure the expansion of the air bubbles contained in the dried resin mentioned previously. The heat treatment step makes it possible to cause, on the one hand, the expansion of microbubbles of air contained in the resin and, on the other hand, the polymerization of the latter. This achieves the formation of open microcavities forming a plurality of obstacles to the propagation of the surface mechanical wave and of the local waves.

In a preferred embodiment, it is indicated that the resin Res can advantageously be formed by a paint comprising an acrylic base.

By way of nonlimiting example, it is indicated that particularly significant and satisfactory trials have been carried out using an acrylic base marketed under the designation PRINTOFIX FLOCK LW and under the product code 254210-100 by the company CLARIANT S.A. in France. In a nonlimiting manner, it is indicated that this acrylic base consists of binders and acrylic thickeners together with an expansion agent.

Furthermore, comparable trials have been performed using a paint. The paint used was the paint marketed in France by the company LEFRANC & BOURGEOIS under the reference Deco-Velours.

Another paint has proved particularly suitable for the implementation of the method and of the material which are the subject of the invention, this being the paint marketed throughout the world under the designation “brod'express” by the company PÉBÉO. The companies LEFRANC & BOURGEOIS and PEBEO have their headquarters in France.

In the course of all the trials performed, and in particular in the mode of carrying out the expansion process as described previously in conjunction with FIG. 2f, it was possible to note that the heat treatment step described previously actually makes it possible to cause the expansion of air microbubbles contained in the resin Res and thus the formation of open microcavities, forming the plurality of obstacles to the propagation of the surface mechanical wave and of the local waves. These open microcavities constitute a layer of air in direct contact with the ambient air and which furthermore causes a boundary layer improving the coupling of the diaphragm to the ambient air, when the former is set into motion relative to the latter.

A specific mode of implementing the method, which is the subject of the present invention will now be given in conjunction with FIG. 2g.

In this embodiment, the method which is the subject of the invention consists in forming the support from a continuous structure made of a specified material, then in forming on at least one of the faces of the support an absorbent coating which absorbs this surface mechanical wave and the local waves from the same material, the coating being expanded, however, and then exhibiting a lower apparent density than that of the support.

To implement the method which is the subject of the invention in this particular embodiment, a solution can consist, as represented in FIG. 2g, in forming a provisional support S′ and, on a face of this provisional support S′, in forming a coating R′ of a material such as the acrylic base mentioned previously in the description. The coating R′ on the support S′ is represented at 2) in FIG. 2g. It is understood in particular that the coating R′ can be produced by several successive layers of the aforesaid acrylic base marketed by the company CLARIANT. By way of nonlimiting example, the provisional support S′ can be formed by paper made from bamboo pulp, with a grammage of between 10 and 12 g/m², or silicone.

Step 2 is then followed by a step 3 in which the assembly formed by the support S′ and the coating R′ is then, in step 3, subjected to compression P so as to make the assembly more rigid and in particular to densify the coating R′.

The assembly consisting of the support S′ and the densified coating R′ can then be subjected to a process of mechanical treatment making it possible to remove the support S′, this mechanical treatment thus making it possible to obtain, from the coating R′ alone, a support S made from the compressed material formed by the acrylic base mentioned previously. The mechanical elimination treatment can be performed by debonding under controlled ventilation FA, as represented at point 4) of FIG. 2g. At the end of the aforesaid step a support S is available which, in step 5, can then be subjected to the coating process making it possible to add the coating R, the assembly consisting of the support S and the coating R being subjected to the method as described previously in conjunction with FIGS. 2b to 2f.

It is understood that under these conditions, the final coating R and support S, although they are made of one and the same material, exhibit a different apparent density, that of the coating R being lower than that of the support S.

A more detailed description of the material absorbing a surface mechanical wave generated by local waves, these waves being capable of generating interference phenomena in relation to a pressure wave whose direction of propagation is orthogonal to this surface, will now be given in conjunction with FIGS. 3a to 3c. With reference to FIG. 3a, it is indicated that the aforesaid material comprises a base constituted by a support S delimiting the surface mentioned previously, this support being formed from a continuous structure. The support S exhibits a specified rigidity in a direction substantially orthogonal to the surface of the support.

Generally, it is indicated that the support can be constituted by paper, metal such as aluminum, titanium, a woven structure of nylon threads, it being advantageously possible for these various supports to be constructed in sheet form. The rigidity of the aforesaid sheets, in the direction orthogonal to the surface of these sheets, can advantageously correspond to a value of Young's modulus E such that 1×10⁹ Pa≦E≦1100×10⁹ Pa.

The range of values of the Young's modulus of the materials used covers materials as diverse as:

cellulose pulp;

polycarbonate;

glass reinforced polymer;

graphite polymer;

aluminum;

titanium;

ceramics.

Furthermore, the material as represented in FIG. 3a comprises an absorbent coating which absorbs a surface mechanical wave and local waves and which is disposed on at least one of the faces of the support S.

Generally, the absorbent coating R exhibits a plurality of obstacles to the propagation of the surface mechanical wave and the local waves. These obstacles are represented in a nonlimiting manner in FIG. 3a by a granular structure, denoted G in the aforesaid figure.

With reference to the process for implementing the method which is the subject of the present invention, it is indicated that the coating R can be constituted by a structure chosen from plushes, velvets, cellular foams for example.

FIG. 3b represents a photograph, with a magnification of 100, of a preferred embodiment of the coating R when the latter is made from the acrylic base mentioned previously in the description.

On observing FIG. 3b, it is indicated that the constituent structure of the absorbent coating R comprises a plurality of outgrowths regularly distributed inside and on the surface of the coating, these outgrowths extending in a direction substantially orthogonal to the inside and to the external surface of the coating over a height of between 2 μm and 500 μm, via successive layers for example.

It is understood in particular that during the step for expanding the coating R, and with reference to FIG. 3b, the microbubbles of air contained in the granular microspheres of the structure represented are subjected to an expansion phenomenon which causes the partial destruction of some of the aforesaid microspheres, this destruction creating the outgrowths mentioned previously, which extend in a direction substantially orthogonal to the external surface of the coating.

Thus, each expanded and degraded microsphere constitutes in relation to the surface mechanical wave and to the local waves a network of mass/spring type dampers absorbing the mechanical energy of the surface mechanical wave and of the local waves generating them. Under these conditions, the surface state of the coating R consists of asperities and of microcavities trapping air, these cavities being in essence open. Such a surface state creates, at the surface of the coating R, and of the diaphragm, a layer of air which substantially improves the coupling of the diaphragm with the air which it sets into motion. This phenomenon can thus be likened to the concept of a boundary layer of flows. This improved coupling allows better reproduction of the wavefront emitted by the diaphragm.

Finally, in the case of the implementation of the method which is the subject of the present invention as represented in FIG. 2g, it is understood in particular, as represented in FIG. 3c, that the support S and the coating R are constituted by one and the same material such as the acrylic base mentioned previously in the description. Of course, the expanded coating R exhibits a lower apparent density P2 than the apparent density Pi of the support S.

It is of course understood that, through a specific adaptation of implementation of the method, represented in FIG. 2g, which is the subject of the present invention, it is also possible to obtain successive layers of different densities between the support S and the coating R as a function, on the one hand, of the pressure applied to the constituent layers of the support S, and, on the other hand, of the heat treatment applied to the constituent layers of the coating R.

A more detailed description of an electroacoustic transducer in accordance with the subject of the present invention will now be given in conjunction with FIG. 4.

In the aforesaid FIG. 4, the same elements comprise the same references as those indicated previously in conjunction with FIG. 1, in particular as regards the excitation coil B, the suspension SU, the diaphragm ME and the rigid frame FR.

Apart from the aforesaid elements, it is indicated that in the nonlimiting case represented in FIG. 4 where the electroacoustic transducer constitutes the tweeter of an acoustic cabinet, a motor constituted by a magnet, pole pieces and as air gap. This motor, of conventional type, is therefore not represented in detail in the drawing. The diaphragm ME is secured to the coil B, which is connected to the wire for excitation by the audio signal. Finally, a cover made of molded material exhibiting a central hollow is intended to be placed on the frame FR, the diaphragm ME and the suspension SU in such a way as to allow free play of the diaphragm ME in the central hollow of the cover, when the latter is propelled by the motor.

In accordance with the subject of the present invention, the diaphragm ME consists of a material such as defined and described previously in conjunction with FIGS. 3a to 3c.

Of course, the electroacoustic transducer described in conjunction with FIG. 4 can be implemented in accordance with the subject of the present invention for any type of acoustic transducer other than a tweeter, the diaphragm under these conditions being, however, shaped according to a surface of revolution with respect to an axis of symmetry. The electroacoustic transducer which is the subject of the present invention can also be implemented in the form of plane loudspeakers or transducers, with a flexible or rigid diaphragm, this type of loudspeaker or of transducer possibly not even comprising any rigid frame catering for suspension. Furthermore, the material which is the subject of the invention appears to be well suited to cater for the coating of the walls and of the diaphragms of horn loudspeakers or compression chamber loudspeakers. Under these conditions, it is understood that the diaphragm ME exhibits a substantially homogeneous rigidity corresponding to that of the material which is the subject of the present invention, independently of the zone of deformation of this diaphragm in relation to this axis of symmetry. This makes it possible, by virtue of the elimination or the significant attenuation of the surface mechanical waves and of the local waves as well as by virtue of the creation of a substantially uniform deformation of the diaphragm, in the absence of appreciable microdeformation, to improve the phase coherence of the acoustic waves reproduced by the electroacoustic transducer which is the subject of the invention.

It is understood in particular that when the audio signal causes a quasi-random excitation of the diaphragm ME by way of the magnetic motor formed by the magnetic core NM and the coil B, it being possible for the randomness to be understood as depending on the succession of sounds and the intensity of these sounds as a function of the type of acoustic signal reproduced, the pulsations generated at the level of the diaphragm ME in fact excite all the resonance modes and micromodes of the aforesaid diaphragm, these modes and micromodes together corresponding in fact to the phenomenon of coloration related to the nature of the material and of the structure of the diaphragm used.

The material which is the subject of the present invention implemented to make such a diaphragm then behaves as an absorber of surface mechanical waves and local waves generated at the level of the aforesaid diaphragm. It also ensures better coupling with the ambient air, owing to the phenomenon akin to that of a boundary layer, cited previously.

Comparative trials for a loudspeaker and a tweeter were carried out when the diaphragm of a loudspeaker of a conventional tweeter was replaced with a diaphragm, a so-called treated diaphragm, in accordance with the subject of the present invention. The treated diaphragm was a diaphragm made of cellulose pulp+binder. The results of the comparative trials are reported hereinbelow in conjunction with FIGS. 5a, 5b and 6a, 6b.

In the aforesaid figures, the amplitude in dB, scale from 0 to −30 dB, of the sound signal has been represented as ordinate and the time in milliseconds and the frequency in Hz have been represented as 2D horizontal abscissae. For the two treated types of loudspeaker and tweeter transducer, a considerable reduction in the tailoffs over time is observed. The aforesaid tailoffs in amplitude and in duration stem directly from the quality of the inherent damping of these transducers, in particular of their diaphragm.

Thus, it may be observed that the method and the material which are the subject of the invention make it possible to obtain quasi-complete damping of the passband of the transducer just 0.28 ms after the emission of the signal at the time origin, whereas a conventional transducer exhibits tailoffs up to 1.76 ms, especially at 2000 and 6000 Hz.

1. A method of making a material absorbing a surface mechanical wave generated by local waves which is capable of generating interference phenomena in relation to a pressure wave whose direction of propagation is substantially orthogonal to said surface, characterized in that it consists in:
forming a support delimiting this surface from a continuous structure, said support exhibiting a specified rigidity in a direction substantially orthogonal to the surface of this support;
forming on at least one of the faces of said support an absorbent coating which absorbs this surface mechanical wave and the local waves, said absorbent coating exhibiting a plurality of obstacles to the propagation of said surface mechanical wave and of the local waves.

2. The method as claimed in claim 1, characterized in that said support is formed by a continuous structure, a composite structure, a woven or unwoven structure of fibers chosen from the group of inorganic or synthetic fibers.

3. The method as claimed in claim 1 or 2, characterized in that said support is shaped by forming, thermoforming, molding or stamping according to a predetermined forming profile, blanking from a plate.

4. The method as claimed in one of claims 1 to 3, characterized in that the step consisting in forming an absorbent coating consists in adding a structure chosen from the group of plushes, velvets, cellular foams to said at least one of the faces of the support.

5. The method as claimed in claim 4, characterized in that the step consisting in forming said absorbent coating consists:
in subjecting said support to a surfactant accompanied by a wetting agent;
in depositing at least one layer of a resin comprising an acrylic base on at least one of the faces of said support;
in subjecting the assembly consisting of the support furnished with at least one layer of this resin to a process for expanding said resin, thereby making it possible to generate a surface structure of the plush, velvet or cellular foam type on the surface of said at least one layer of resin and of the support.

6. The method as claimed in claim 5, characterized in that said resin is formed by a paint comprising an acrylic base.

7. The method as claimed in one of claims 5 or 6, characterized in that said expansion process comprises at least:
a step of drying said at least one layer of resin;
a step of heat treatment of said resin making it possible to cause, on the one hand, the expansion of microbubbles of air contained in said resin and, on the other hand, the polymerization of this resin so as to engender the formation of open microcavities forming said plurality of obstacles to the propagation of said surface mechanical wave and of said local waves.

8. The method as claimed in one of claims 1 to 7, characterized in that it consists in forming said support from a continuous structure of a first material, then in forming on at least one of the faces of said support an absorbent coating which absorbs this surface mechanical wave and the local waves from said first material, said coating being expanded and exhibiting a lower apparent density than that of the support.

9. A material absorbing a surface mechanical wave generated by local waves which are capable of generating interference phenomena in relation to a pressure wave whose direction of propagation is substantially orthogonal to said surface, characterized in that it comprises:
a base consisting of a support delimiting this surface, which support is formed from a continuous structure, said support exhibiting a specified rigidity in a direction substantially orthogonal to the surface of this support;
an absorbent coating which absorbs this surface mechanical wave and the local waves, and is disposed on at least one of the faces of said support, said absorbent coating exhibiting a plurality of obstacles to the propagation of said surface mechanical wave and of the local waves.

10. The material as claimed in claim 9, characterized in that said support is formed by a continuous structure, a woven or unwoven structure of fibers chosen from the group of inorganic or synthetic fibers.

11. The material as claimed in one of claims 9 or 10, characterized in that said absorbent coating which absorbs this surface mechanical wave and the local waves consists of a structure chosen from the group of plushes, velvets, cellular foams, said structure comprising open cavities or zones constituting a layer for coupling the coating to the ambient air.

12. The material as claimed in claim 11, characterized in that said structure comprises a plurality of outgrowths regularly distributed inside and on the surface of said coating, said outgrowths extending in a direction substantially orthogonal to the inside and to the external surface of said coating over a height of between 2 μm and 500 μm.

13. The material as claimed in one of claims 9 to 12, characterized in that said coating consists of a resin or paint comprising an acrylic base.

14. The material as claimed in one of claims 9 to 13, characterized in that said support and said coating consist of one and the same material, said coating being expanded and exhibiting a lower apparent density than the apparent density of the support.

15. An electroacoustic transducer, comprising an electromagnetic motor and a diaphragm furnished with an excitation coil, characterized in that said diaphragm is constructed from a material according to one of claims 9 to 14.

16. The electroacoustic transducer as claimed in claim 15, characterized in that said diaphragm is shaped according to a surface of revolution with respect to an axis of symmetry, said diaphragm exhibiting a rigidity substantially homogeneous to said material regardless of the zone of deformation of this diaphragm in relation to this axis of symmetry, thereby making it possible, by virtue of the elimination or the attenuation of the surface mechanical waves and of the local waves and by virtue of the creation of a substantially uniform deformation of the diaphragm, to improve the phase coherence of the acoustic waves reproduced by the electroacoustic transducer and the coupling of the diaphragm to the ambient air.
